(19) United States
(12) Patent Application Publication
(10) Pub. No.: US 2011/0285712 A1
(43) Pub. Date: Nov. 24, 2011

(54) IMAGE SIGNAL PROCESSING APPARATUS, LIGHT-EMITTING APPARATUS, 3D IMAGE VIEWING GLASSES, IMAGE SIGNAL PROCESSING SYSTEM, AND IMAGE SIGNAL PROCESSING METHOD

(76) Inventors: Kumiko Arai, Osaka (JP); Shinya Kiuchi, Osaka (JP); Natsuki Saito, Osaka (JP); Yoshiaki Owaki, Osaka (JP)

(21) Appl. No.: 13/113,268

(22) Filed: May 23, 2011

(30) Foreign Application Priority Data
May 24, 2010 (JP) 2010-118002

(51) Int. Cl. G06T 15/50

(52) U.S. Cl. 345/426

(57) ABSTRACT

An image signal processing apparatus includes an output unit that outputs an image, a detection unit that detects that the output unit is outputting a 3D image, and a light modulation control unit that causes a light emitting apparatus to reduce luminance of a light emitting unit thereof, in response to the detection by the detection unit that the output unit is outputting a 3D image.

### BACKGROUND OF THE INVENTION

(1) Field of the Invention

The present invention relates to an image signal processing apparatus that outputs a three-dimensional (hereinafter, 3D) image, and more particularly to an image signal processing apparatus that operates in association with a light emitting apparatus and/or 3D image viewing glasses, or the like.

(2) Description of the Related Art

Techniques of measuring an illumination status of an actual space and adjusting luminance of a display unit have conventionally been known. Also, 3D image reproduction apparatuses are known that alternately reproduce a different image for the left eye and the right eye respectively, so that a user viewing such an image through 3D-exclusive glasses can perceive the depth and stereoscopic vision of the space in the image owing to a parallax between the eyes, for example as disclosed in Japanese Unexamined Patent Application Publication No. 2004-88757.

### SUMMARY OF THE INVENTION

The foregoing techniques allow the user to view a realistic stereoscopic image, because of the adjustment of the luminance of the display unit in accordance with the illumination status. However, the amount of light incident upon the eyes of the viewer from the 3D image through the 3D-exclusive glasses, the transmittance of which fluctuates with time, is smaller in comparison with a 2D image, and hence the display unit may appear too dark to the user. Accordingly, in the case where the user views the 3D image in a bright viewing circumstance, the contrast of the image is lowered, resulting in degraded image quality.

With an object to solve the foregoing problem, the present invention provides an image signal processing apparatus capable of suppressing degradation in quality of a 3D image perceived by a viewer.

In an aspect, the present invention provides an image signal processing apparatus that operates in association with a light emitting apparatus including a light emitting unit, the image signal processing apparatus comprising an output unit configured to output an image, a detection unit configured to detect an output of a 3D image from the output unit, and a light modulation control unit configured to cause the light emitting apparatus to reduce a luminance of the light emitting unit, when the detection unit detects an output of the 3D image from the output unit.

The image signal processing apparatus thus configured reduces the luminance of the light emitting unit provided around the viewer when the 3D image is outputted, thereby allowing the displayer displaying the 3D image to appear relatively brighter to the viewer. As a result, the viewer can watch the 3D image in an optimum viewing circumstance.

In the image signal processing apparatus, the light modulation control unit may be configured to gradually reduce the luminance of the light emitting unit over a predetermined period of time. Such a gradual change of the viewing circumstance prevents the viewer from feeling uncomfortable.

Also, in the image signal processing apparatus, the detection unit may further be configured to detect a feature of the 3D image outputted from the output unit, and the light modulation control unit may be configured to change an amount of reduction in luminance of the light emitting unit, in accordance with the feature of the 3D image detected by the detection unit.

For example, the detection unit may be configured to detect an amount of crosstalk of the 3D image outputted from the output unit, and the light modulation control unit may be configured to reduce the luminance of the light emitting unit by the larger amount, the larger the crosstalk amount detected by the detection unit is.

Alternatively, the output unit may includes an image signal output unit configured to alternately output a right eye image and a left eye image having a parallax between each other, and a synchronization signal output unit configured to output a synchronization signal that opens a lens of 3D image viewing glasses worn by a viewer corresponding to an image outputted by the image signal output unit and closes the other lens of the 3D image viewing glasses, and the detection unit may be configured to detect a time during which the lens of the 3D image viewing glasses is open, and the light modulation control unit may be configured to reduce the luminance of the light emitting unit by the larger amount, the shorter the time detected by the detection unit during which the lens of the 3D image viewing glasses is open is.

In the case where the crosstalk amount is large, the shutter of the 3D image viewing glasses is open for a shorter time, which makes the viewer to perceive lowered luminance. Performing the foregoing adjustment in such a case allows the luminance of the displayer to be relatively increased. For such adjustment, the detection unit may directly detect the crosstalk amount of the image being outputted from the output unit, or detect the time during which the lens of the 3D image viewing glasses is open, i.e., the shutter is open.

Alternatively, the output unit may be configured to output the 3D image in one of a plurality of output modes for each of which a different peak luminance is specified, the detection unit may be configured to detect the output mode of the 3D image outputted from the output unit, and the light modulation control unit may be configured to reduce the luminance of the light emitting unit by the larger amount, the lower the peak luminance identified from the output mode detected by the detection unit is. Such an arrangement provides an optimum viewing circumstance in accordance with the output mode.

Also, the detection unit may be configured to detect a scene change of the 3D image outputted from the output unit, and the light modulation control unit may be configured to reduce the luminance of the light emitting unit in the case where a luminance of an image following the scene change detected by the detection unit is lower than a luminance of an image preceding the scene change, and to reduce the luminance of the light emitting unit by the larger amount, the lower the luminance of the image following the scene change detected by the detection unit is.

The light modulation control unit may further be configured to increase the luminance of the light emitting unit in the case where luminance of an image following the scene change detected by the detection unit is higher than luminance of an image preceding the scene change, and to increase the luminance of the light emitting unit by the larger amount, the higher the luminance of the image following the scene change detected by the detection unit is.

Adjusting thus the luminance of the light emitting unit following up the scene change provides an optimum viewing circumstance.

Further, the detection unit may further be configured to detect that the output unit has stopped outputting the 3D image, and the light modulation control unit may further be configured to increase the luminance of the light emitting unit, when the detection unit detects that the 3D image has stopped being outputted.

For example, in the case where the light emitting unit is an interior lighting apparatus, keeping the luminance of the light emitting unit lowered after the display is switched from the 3D image to a 2D image makes the viewer feel the viewing circumstance relatively darker and the displayer relatively brighter, since a 2D image generally provides higher luminance than a 3D image. In such a case, accordingly, increasing the luminance of the light emitting unit prevents the viewer from feeling dazzled by the displayer. Here, the expression “stop outputting the 3D image” includes not only switching the display to a 2D image but also suspending or finishing the 3D image display.

Further, the image signal processing apparatus may be incorporated therein with the light emitting apparatus. In other words, the image signal processing apparatus and the light emitting apparatus may be an integral apparatus or independent apparatuses. More specifically, the image signal processing apparatus may control the luminance of a built-in light emitting unit, or the luminance of a light emitting unit provided in an external apparatus.

In another aspect, the present invention provides a light emitting apparatus that operates in association with an image signal processing apparatus, the light emitting apparatus comprising a light emitting unit configured to change luminance, and a light modulation unit configured to reduce the luminance of the light emitting unit when the image signal processing apparatus outputs a 3D image.

In still another aspect, the present invention provides 3D image viewing glasses that operate in association with an image signal processing apparatus and a light emitting apparatus including a light emitting unit, the 3D image viewing glasses comprising a synchronization signal reception unit configured to receive a synchronization signal indicating a timing for a change in transmittance of left and right lenses from the image signal processing apparatus, a left and right pair of lenses configured to change transmittance in accordance with the synchronization signal received by the synchronization signal reception unit, and a light modulation control unit configured to cause the light emitting apparatus to reduce luminance of the light emitting unit, when the synchronization signal reception unit receives the synchronization signal.

In still another aspect, the present invention provides an image signal processing system comprising an image signal processing apparatus, and a light emitting apparatus, the image signal processing apparatus including an output unit configured to output an image, a detection unit configured to detect an output of a 3D image from the output unit, and a light modulation control unit configured to cause the light emitting apparatus to reduce luminance of a light emitting unit thereof, when the detection unit detects an output of the 3D image from the output unit, and the light emitting apparatus including the light emitting unit configured to change luminance, and a light modulation unit configured to reduce the luminance of the light emitting unit under control by the light modulation control unit.

In still another aspect, the present invention provides a method of processing an image signal to be performed utilizing an image signal processing apparatus and a light emitting apparatus in association therebetween, the method comprising causing the image signal processing apparatus to output an image, detecting an output of a 3D image from the image signal processing apparatus, and controlling modulation of light, including causing the light emitting apparatus to reduce luminance of a light emitting unit thereof in response to the detecting an output of a 3D image from the image signal processing apparatus.

Thus, the present invention enables the luminance of a light emitting unit to be adjusted in accordance with an image outputted from an output unit, thereby allowing a viewer to watch a 3D image in an optimum viewing circumstance.

### FURTHER INFORMATION ABOUT TECHNICAL BACKGROUND TO THIS APPLICATION

The disclosure of Japanese Patent Application No. 2010-118002 filed on May 24, 2010 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a perspective view showing an appearance of apparatuses constituting an image signal processing system;

FIG. 2 is a functional block diagram of the apparatuses constituting the image signal processing system;

FIG. 3A is a flowchart showing an operation of a TV set exemplifying an image signal processing apparatus;

FIG. 3B is a flowchart showing an operation of a reproduction apparatus exemplifying a light emitting apparatus;

FIGS. 4A to 4C are graphs respectively showing an example of a change in luminance with time of a light emitting unit controlled by a light modulation control unit;

FIG. 5 is a graph showing an example of a change in luminance of the light emitting unit following a scene change; and

FIGS. 6A to 6C are graphs respectively showing an example of a change in luminance of the light emitting unit caused by switching between 2D and 3D images.

### DESCRIPTION OF THE PREFERRED EMBODIMENTS

Hereunder, embodiments of the present invention will be described referring to the drawings.

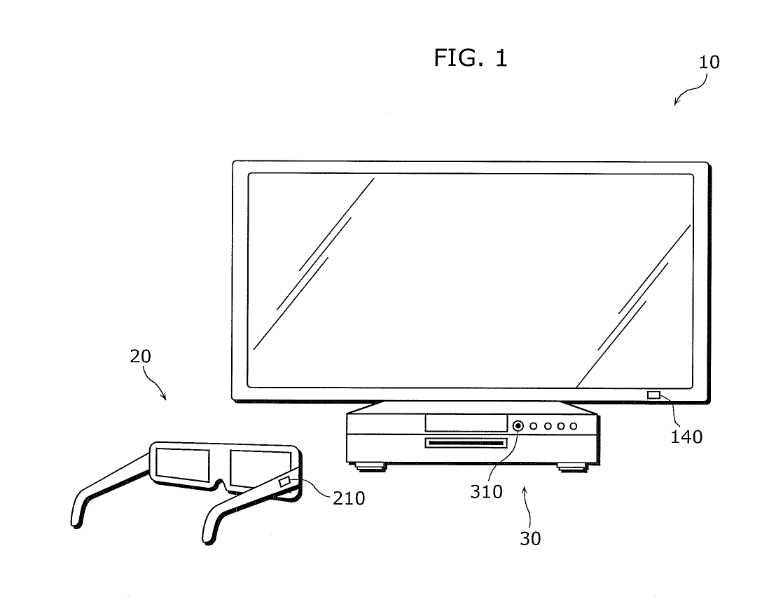

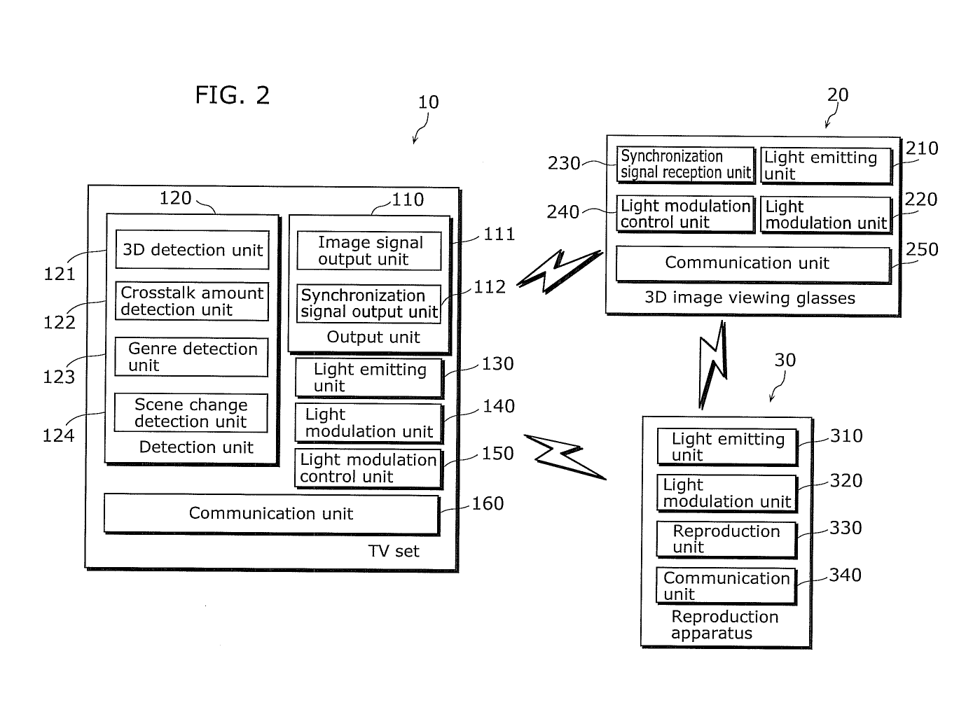

Referring first to FIGS. 1 and 2, an image signal processing system according to an embodiment of the present invention will be described. FIG. 1 is a perspective view showing an appearance of apparatuses constituting the image signal processing system. FIG. 2 is a functional block diagram of the apparatuses constituting the image signal processing system.

The image signal processing system according to this embodiment includes, as shown in FIG. 1, a TV set 10, 3D image viewing glasses 20, and a reproduction apparatus 30. The TV set 10 shown in FIG. 1 is capable of serving as an image signal processing apparatus. Likewise, the TV set 10, the 3D image viewing glasses 20, and the reproduction apparatus 30 shown in FIG. 1 are capable of serving as a light emitting apparatus.

The TV set 10 is a displayer capable of displaying a 3D image. The TV set 10 includes, as shown in FIG. 2, an output unit 110, a detection unit 120, a light emitting unit 130, a light modulation unit 140, a light modulation control unit 150, and a communication unit 160.

The output unit 110 includes an image signal output unit 111 that outputs an image, and a synchronization signal output unit 112 that outputs a synchronization signal to the 3D image viewing glasses 20.

The image signal output unit 111 outputs a 2D image or a 3D image acquired from the reproduction apparatus 20, or a tuner (not shown). Here, the 3D image referred to in this embodiment is created by alternately outputting, frame by frame (or picture by picture), a left eye image and right eye image having a parallax between each other, from the image signal output unit 111.

The image signal output unit 111 according to this embodiment is a display unit that displays an image. Specific examples of the display unit include a liquid crystal display, a plasma display, an organic electro-luminescence (EL) display, and a projector screen.

The synchronization signal output unit 112 outputs a synchronization signal to the 3D image viewing glasses 20, in synchronization with the output of the right eye image and the left eye image from the image signal output unit 111. The synchronization signal serves to change the transmittance of each of left and right lenses of the 3D image viewing glasses 20.

More specifically, the synchronization signal output unit 112 increases the transmittance of the right eye lens and decreases the transmittance of the left eye lens, when the image signal output unit 111 outputs the right eye image. In other words, the right eye image is made viewable only through the right eye lens. Likewise, the synchronization signal output unit 112 increases the transmittance of the left eye lens and decreases the transmittance of the right eye lens, when the image signal output unit 111 outputs the left eye image. In other words, the left eye image is made viewable only through the left eye lens.

Examples of the method of changing the transmittance include opening a shutter provided on the lens thereby increasing the transmittance, and closing the shutter thereby decreasing the transmittance.

The detection unit 120 detects a feature of the image signal outputted from the image signal output unit 111. The detection unit 120 includes, as shown in FIG. 2, a 3D detection unit 121, a crosstalk amount detection unit 122, a genre detection unit 123, and a scene change detection unit 124.

The 3D detection unit 121 detects that the image signal output unit 111 is outputting, and has stopped outputting, a 3D image. Examples of the detection method of the 3D image include detecting that the frame rate of the image being outputted from the image signal output unit 111 is 120 Hz, and that the synchronization signal output unit 112 is outputting the synchronization signal. In the case where the image is specified as a 3D image according to a broadcasting standard or transmission standard, a method complying with the standard may be adopted to detect that a 3D image is being outputted.

Alternatively, 3D detection unit 121 may analyze an image taken by a camera (not shown) shooting the viewer of the TV set 10, to thereby detect a 3D image. First the 3D detection unit 121 detects that the viewer wears glasses, from the image taken by the camera. In the case where the respective frame rate of the right eye image and the left eye image constituting the 3D image is 60 Hz, the 3D image viewing glasses 20 opens and closes, in synchronization therewith, the shutter of the left and right lenses 60 times per second respectively.

Accordingly, the viewer can be detected to be watching a 3D image if, upon shooting the viewer wearing the 3D image viewing glasses 20 with the camera at a shutter speed of 1/60 seconds, the shutter of one of the left and right lenses is open and the shutter of the other lens is closed.

The crosstalk amount detection unit 122 detects an amount of crosstalk incidental to a 3D image outputted from the image signal output unit 111. The crosstalk herein refers to an afterimage of a left (right) eye image immediately preceding a right (left) eye image actually displayed.

Examples of the detection method of the crosstalk amount include calculating the crosstalk amount on the basis of the luminance of chronically adjacent left and right images and a display characteristic of the displayer. Alternatively, in the case where the timing to open and close the shutter of the left and right lenses of the 3D image viewing glasses 20 is adjusted depending on the crosstalk amount, the crosstalk amount may be detected on the basis of the opening and closing pattern of the shutter.

More specifically, the synchronization signal output unit 112 may output such a synchronization signal that shortens the opening time of the shutter, in other words that extends the time during which the both shutters are closed, the larger the crosstalk amount is. Accordingly, the crosstalk amount detection unit 122 may calculate the ratio of the opening time of the shutter of the 3D image viewing glasses 20 from the foregoing image of the viewer taken by the camera, and decide that the crosstalk amount is larger, as the ratio of the shutter opening time becomes smaller.

The genre detection unit 123 detects a genre of the image outputted from the image signal output unit 111. Examples of the genre include a movie picture, news, sports, drama, music, variety program, animation, theater performance, hobby, welfare, and so forth.

Although the method of detecting the genre is not specifically limited, for example an output mode of the TV set 10 may be utilized for detecting the genre. More specifically, the image signal output unit 111 outputs a 3D image in one of a plurality of output modes for each of which a different peak luminance is specified. Typically, the output mode is selected by the user in accordance with the genre of the image to be viewed.

Examples of such output modes include, but are not limited to, a theater mode given a lowest peak luminance and hence suitable for displaying a movie picture or the like, a dynamic mode given a highest peak luminance and hence suitable for displaying sports or the like, and a standard mode given a peak luminance of a level between those of the theater mode and the dynamic mode. Thus, the genre detection unit 123 may detect such an output mode to thereby presume the genre of the image outputted from the image signal output unit 111.

Alternatively, the genre detection unit 123 may detect the genre of the image outputted from the image signal output unit 111 on the basis of information from an electronic program guide (EPG).

The scene change detection unit 124 detects a scene change in images outputted from the image signal output unit 111. Examples of the detection method of the scene change include calculating an average picture level (APL) of chronically adjacent two left (right) eye images and deciding that a scene change has taken place in the case where the calculated APL exceeds a predetermined threshold.

The light emitting unit 130 can be exemplified by everything that can be located on a surface of the TV set 10 and emits light, such as an LED lamp indicating that the power is on, and a 7-segment display unit for displaying time information (current time, reproduction time, recording time, and so on), to cite a few. This also applies to light emitting units 210, 310 to be subsequently described. In the TV set 10, however, the display unit (image signal output unit 111) is excluded from the light emitting unit 130. The light emitting unit 130 is configured to change the luminance thereof.

The light modulation unit 140 controls the luminance of the light emitting unit 130, under the control of the light modulation control unit 150.

The light modulation control unit 150 controls the luminance of the light emitting unit of the light emitting apparatus, in accordance with a detection result provided by the detection unit 110. A specific controlling method will be subsequently described. Here, the light modulation control unit 150 can control the luminance of the light emitting unit 130 provided in the same apparatus, as well as the luminance of the light emitting units 210, 310 provided in external apparatuses.

Here, the light emitting apparatus can be exemplified by everything that includes a light emitting unit, such as the TV set 10, the 3D image viewing glasses 20, and the reproduction apparatus 30 shown in FIG. 1. Thus, the light modulation control unit 150 may control the luminance of the light emitting unit 130 in the same apparatus (in this embodiment, TV set 10), and the luminance of the light emitting units 210, 310 in external apparatuses (in this embodiment, 3D image viewing glasses 20 and reproduction apparatus 30, respectively).

Specifically, the light modulation control unit 150 generates a light modulation signal that specifies the luminance and chroma of the light emitting units, and transmits the light modulation signal to the light modulation unit 140 through an internal bus (not shown), and to the light modulation units 220, 320 through the communication unit 160.

The communication unit 160 serves as an interface for communication with external apparatuses such as the 3D image viewing glasses 20 and the reproduction apparatus 30. The communication method is not specifically limited, but may be wired communication or wireless communication. Examples of the wired communication include a high-definition multimedia interface (HDMI), and Ethernet (registered trademark). Examples of the wireless communication include a wireless HD, Bluetooth, and infrared communication.

The 3D image viewing glasses 20 include a left and right pair of lenses the transmittance of which changes with time. The 3D image viewing glasses 20 include, as shown in FIG. 2, the light emitting unit 210, a light modulation unit 220, a synchronization signal reception unit 230, a light modulation control unit 240, and a communication unit 250.

The light modulation unit 220 controls the luminance of the light emitting unit 210, under the control of the light modulation control unit 150 or 240 of the TV set 10 or the 3D image viewing glasses 20, respectively.

The synchronization signal reception unit 230 receives a synchronization signal outputted from the TV set 10. The 3D image viewing glasses 20 individually controls the transmittance of the left and right lenses, more specifically the opening and closing action of the shutter of the left and right lenses, in accordance with the synchronization signal received by the synchronization signal reception unit 230.

The light modulation control unit 240 generates a light modulation signal in accordance with the synchronization signal received by the synchronization signal reception unit 230, and transmits the light modulation signal to the light modulation unit 220 through an internal bus (not shown), and to the light modulation units 140, 320 through the communication unit 250. More specifically, the light modulation control unit 240 decides that a 3D image is outputted from the image signal output unit 111 once the synchronization signal reception unit 230 receives the synchronization signal, and generates a light modulation signal that reduces the luminance of the light emitting unit. In contrast, in the case where the synchronization signal reception unit 230 has not received the synchronization signal, the light modulation control unit 240 decides that the image signal output unit 111 is not outputting a 3D image.

The communication unit 250 serves as an interface for communication with external apparatuses such as the TV set 10 and the reproduction apparatus 30. The communication unit 250 may have the same configuration as the communication unit 160, and hence the description will not be repeated.

The reproduction apparatus 30 serves to reproduce (to output to the display apparatus) an image signal, for example recorded on a recording medium or acquired from an external apparatus. The reproduction apparatus 30 includes, as shown in FIG. 2, a light emitting unit 310, a light modulation unit 320, a reproduction unit 330, and a communication unit 340.

The light modulation unit 320 controls the luminance of the light emitting unit 310, under the control of the light modulation control unit 150 or 240 of the TV set 10 or the 3D image viewing glasses 20, respectively.

The reproduction unit 330 outputs an image recorded on recording media such as a digital versatile disc (DVD), a Blu-ray Disc (BD), a hard disk drive (HDD), and a semiconductor memory, to a display apparatus such as the TV set 10.

The reproduction unit 330 may also convert a broadcast signal received therein into an image signal and output the image signal to the display apparatus such as the TV set 10. Examples of the receivable broadcast wave include all the available broadcast waves such as an analog broadcast wave, surface digital broadcast wave, Broadcast Satellite (BS) wave, and Communication Satellite (CS) wave, to name a few.

The communication unit 340 serves as an interface for communication with external apparatuses such as the TV set 10 and the 3D image viewing glasses 20. The communication unit 340 may have the same configuration as the communication unit 160, and hence the description will not be repeated.

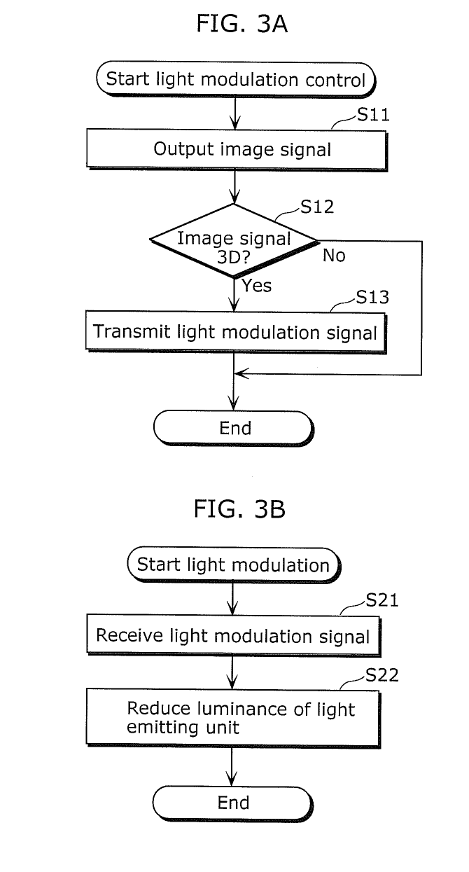

Referring now to FIGS. 3A and 3B, a specific process performed by the light modulation control unit 150 of the TV set 10, exemplifying the image signal processing apparatus, for controlling the luminance of the light emitting unit 310 of the reproduction apparatus 30, exemplifying the light emitting apparatus, will be described in details hereunder. FIG. 3A is a flowchart showing an operation of the TV set 10 exemplifying the image signal processing apparatus. FIG. 3B is a flowchart showing an operation of the reproduction apparatus 30 exemplifying the light emitting apparatus.

First, the image signal output unit 111 starts outputting an image (S11). The image outputted at this step may be one acquired from a broadcast wave through a tuner (not shown), or one acquired from an external apparatus such as the reproduction apparatus 30 through the communication unit 160.

Then the 3D detection unit 121 decides whether the image outputted from the image signal output unit 111 is a 2D image or a 3D image (S12). At the same time, the crosstalk amount detection unit 122, the genre detection unit 123, and the scene change detection unit 124 each detect a feature of the image outputted from the image signal output unit 111.

The light modulation control unit 150 then generates a light modulation signal in response to the detection of the 3D image by the 3D detection unit 121 (Yes at S12), and transmits the generated light modulation signal to the reproduction apparatus 30 through the communication unit 160 (S13).

In turn, the light modulation unit 320 of the reproduction apparatus 30 receives the light modulation signal generated by the light modulation control unit 150, from the TV set 10 through the communication unit 340 (S21). Then the light modulation unit 320 controls the luminance of the light emitting unit 310 in accordance with the light modulation signal thus received (S22). At the step S22, typically, the light modulation unit 320 reduces the luminance of the light emitting unit 310. Accordingly, the light modulation signal may contain such information as an amount of reduction in luminance of the light emitting unit 310, and a time necessary for reducing the luminance of the light emitting unit 310 by the mentioned amount.

Here, the reduction amount of the luminance may be decided by the light modulation control unit 150, for example on the basis of the feature of the image detected by the crosstalk amount detection unit 122, the genre detection unit 123, and the scene change detection unit 124.

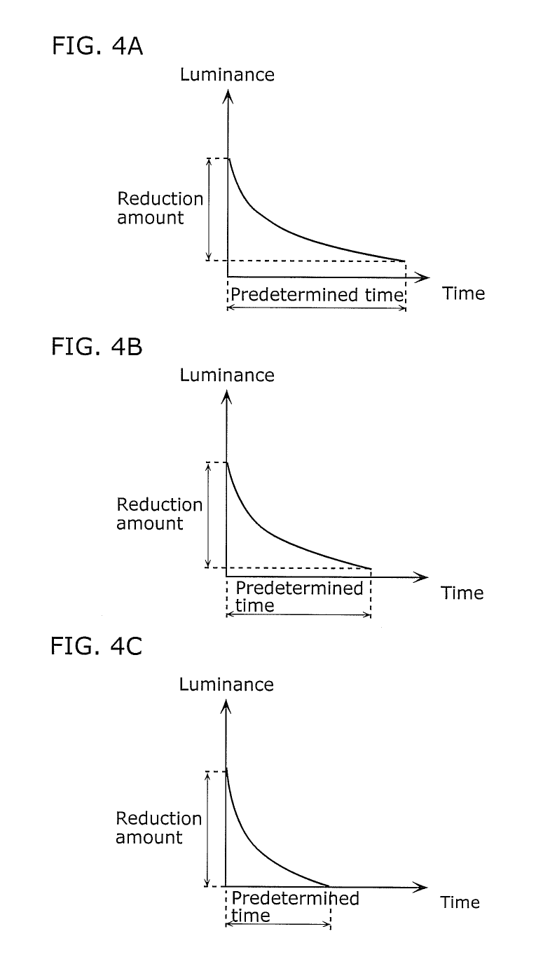

For example, the luminance of the light emitting unit 310 may be reduced by the larger amount, the larger the crosstalk amount detected by the crosstalk amount detection unit 122 is. More specifically, in the case where the crosstalk amount detected by the crosstalk amount detection unit 122 is equal to or smaller than a first threshold, the luminance is reduced by an amount indicated in FIG. 4A. In contrast, in the case where the crosstalk amount is larger than the first threshold but equal to or smaller than a second threshold (>first threshold), the luminance is reduced by an amount indicated in FIG. 4B. In the case where the crosstalk amount is larger than the second threshold, the luminance is reduced by an amount indicated in FIG. 4C.

Such a control process may be performed on the basis of a detection result provided by the genre detection unit 123. Specifically, the luminance of the light emitting unit 310 may be reduced by the larger amount, the lower the peak luminance identified from the output mode detected by the genre detection unit 123 is. Alternatively, in the case where the genre of the image outputted from the image signal output unit 111 is “movie picture”, the luminance may be reduced by a larger amount than in the case of other genre. Thus, it is preferable to increase the reduction amount of the luminance of the light emitting unit 310 the lower the luminance of an image outputted from the image signal output unit 110 is, in other words the less amount of light is incident on the eyes of the viewer.

FIG. 4A is a graph showing a gradual light modulation with time for the light emitting unit 310, performed in the case where the 3D detection unit 121 has detected that the image signal output unit 111 is outputting a 3D image. In the case where the image signal output unit 111 is outputting a 3D image, the luminance of the light emitting unit 310 is reduced with time, as shown in FIG. 4A.

FIG. 4B is a graph showing a light modulation for the light emitting unit 310, performed in the case where the crosstalk amount detection unit 122 has detected a large crosstalk amount. In FIG. 4B, the luminance is controlled so as to be reduced by a larger amount, and in a shorter time before reaching a predetermined luminance, than in FIG. 4A.

In the case where the crosstalk amount is large, the synchronization signal output unit 112 outputs a signal that shortens the shutter opening time of the 3D image viewing glasses 20. This is a process for suppressing a double image originating from the crosstalk. Shortening an earlier portion or a later portion of the shutter opening time of the 3D image viewing glasses 20, or shortening just either portion thereof can prevent the viewer from viewing the image during the switching period between the left and right images, which is the period where the double image is produced. However, such a process incurs reduction in luminance perceived by the viewer, and therefore the light modulation control unit 150 outputs such a light modulation signal that makes the light emitting unit 310 around the viewer darker, thereby performing the light modulation as shown in FIG. 4B. As a result, the viewing circumstance can be made darker, so that the TV set appears relatively brighter.

FIG. 4C is a graph showing a light modulation for the light emitting unit 310, performed in the case where the genre detection unit 123 has detected that the genre of the image being outputted from the image signal output unit 111 is a movie picture. In this case also, the luminance is reduced by a larger amount and in a shorter time before reaching the predetermined luminance, than in FIG. 4A.

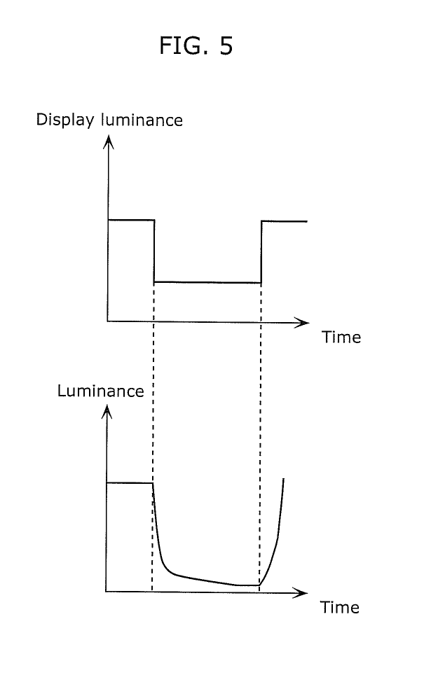

Further, as shown in FIG. 5, the light modulation control unit 150 may compare the luminance between the images preceding and following the scene change detected by the scene change detection unit 124, and reduce the luminance of the light emitting unit 310 in the case where the luminance of the image following the scene change is lower than the luminance of the image preceding the scene change. Here, it is preferable to increase the reduction amount of the luminance of the light emitting unit 310 the lower the luminance of the image following the scene change is.

Likewise, as shown in FIG. 5, the light modulation control unit 150 may increase the luminance of the light emitting unit 310 in the case where the luminance of the image following the scene change is higher than the luminance of the image preceding the scene change. Here, it is preferable to increase the luminance of the light emitting unit 310 by the larger amount, the higher the luminance of the image following the scene change is.

FIG. 5 is a graph showing a light modulation for the light emitting unit 310, performed in the case where the scene change detection unit 124 has detected a scene change. As shown therein, the luminance of the light emitting unit 310 is reduced in response to a reduction in luminance of the image, and increased in response to an increase in luminance of the image.

The scene change detection unit 124 assumes that a scene change has taken place when the APL value has largely fluctuated, in other words when the fluctuation amount of the APL between two adjacent right (left) eye images exceeds a threshold. More specifically, the scene change detection unit 124 assumes that a scene change has taken place when the APL fluctuation amount between a given right (left) eye image and the following right (left) eye image exceeds the threshold.

Here, the scene change may be detected by comparing motion vectors, instead of the APL. Specifically, a scene change may be assumed to have taken place when a total sum of prediction errors of the motion vectors between two adjacent right (left) eye images exceeds a predetermined threshold.

Then the light modulation control unit 150 outputs a light modulation signal in accordance with the amount of luminance fluctuation between the images preceding and following the scene change, thereby performing the light modulation as shown in FIG. 5. In this process, in the case where a bright scene suddenly turns to a dark scene the luminance fluctuates by a large amount, and therefore the light modulation is performed quickly, to thereby secure a viewing circumstance suitable for such a change.

It is to be noted that FIGS. 4A to 5 are merely exemplary, and that different graphs may be employed for performing the light modulation control.

As shown in FIGS. 4A to 4C, the luminance of the light emitting unit 310 may be gradually reduced over a predetermined period of time. This is because a sudden and large change in luminance may make the viewer feel uncomfortable, especially in the case where the light emitting apparatus to be controlled is an interior lighting apparatus. Thus, examples of the light emitting apparatus to be controlled include lighting apparatuses having a light emitting unit such as an LED light, an organic EL light, a fluorescent light, an incandescent light, or a mercury vapor lamp.

In contrast, in the case where the light emitting apparatus to be controlled is the reproduction apparatus 30, the luminance of the light emitting unit 310 may be instantaneously switched from a first luminance to a second luminance lower than the first luminance. Thus, the time necessary for reducing the luminance may be determined, for example, in accordance with the nature of the light emitting apparatus to be controlled.

In the case where a single lighting apparatus exemplifying the light emitting apparatus is present, the modulation pattern may be adjusted depending on a distance between the TV set 10 and the lighting apparatus. In the case where the lighting apparatus is located close to the TV set 10 for example, the adjustment amount of the luminance may be set larger than in the case where the lighting apparatus is located far from the TV set 10.

In the case where a plurality of lighting apparatuses is present, the modulation pattern may be adjusted depending on a distance between the TV set 10 and each of the lighting apparatuses. Specifically, the luminance adjustment amount of the lighting apparatus close to the TV set 10 may be made relatively larger, and the luminance adjustment amount of the lighting apparatus far from the TV set 10 may be made relatively smaller. Such an arrangement allows, in the case where a person other than the viewer is in the viewing space, the viewer to remain in an optimum viewing circumstance, and the person other than the viewer to do what he/she wants to do under a lighting condition only mildly different from a usual condition.

In the case where the light modulation control unit 150 is to control a plurality of light emitting apparatuses, the light modulation control unit 150 may acquire an identifier of the respective light emitting apparatuses and transmit a light modulation signal containing the identifier, to thereby individually control the luminance of the light emitting unit of each light emitting apparatus. The distance between the TV set 10 and each of the light emitting apparatuses may be set by the user with a remote controller, or may be automatically measured on the basis of a round-trip time.

While a 3D image is not detected by the 3D detection unit 121, the 3D image viewing glasses 20 do not operate in synchronization with a 2D image, and hence the shutter of each lens is open. Accordingly, the luminance perceived by the viewer is not reduced to half. Thus, the viewer perceives high luminance when the image signal output unit 111 is outputting a 2D image, and therefore modulating the light emitting unit 310 so as to darken the viewing circumstance makes the displayer relatively much brighter, making the viewer feel dazzled or uncomfortable. In such a case, therefore, the light modulation control unit 150 controls the light emitting unit 310 so as to increase the luminance.

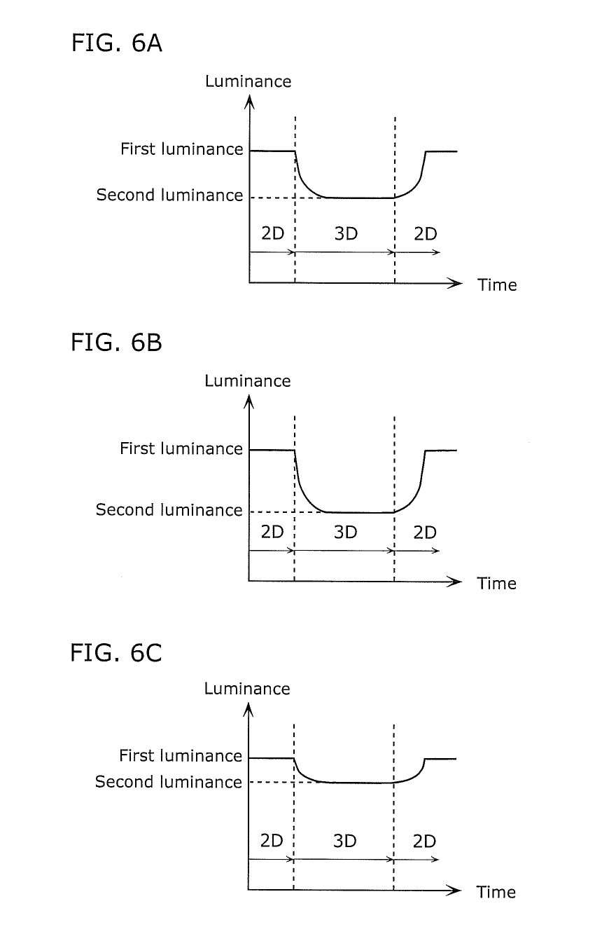

For example, FIGS. 6A to 6C are graphs respectively showing an example of a change in luminance of the light emitting unit 310 caused by switching between images (2D image/3D image) outputted from the image signal output unit 111.

The light modulation control unit 150 maintains the luminance of the light emitting unit 310 at a first luminance, for example as shown in FIG. 6A, while the image signal output unit 111 is outputting a 2D image. Once the image signal output unit 111 outputs a 3D image, the light modulation control unit 150 gradually reduces the luminance of the light emitting unit 310 to a second luminance, which is lower than the first luminance. Then once the image outputted from the image signal output unit 111 is again switched to a 2D image, the light modulation control unit 150 controls the luminance of the light emitting unit 310 so as to return to the first luminance.

FIG. 6B shows an example in which the luminance is adjusted by a larger amount (difference between the first and the second luminance is larger) than in FIG. 6A. In contrast, FIG. 6C shows an example in which the luminance is adjusted by a smaller amount than in FIG. 6A. The light modulation control unit 150 may select an appropriate adjustment amount among FIGS. 6A to 6C, for example on the basis of the detection result from the crosstalk amount detection unit 122, the genre detection unit 123, and the scene change detection unit 124.

Here, although the foregoing embodiment refer to the case where the light modulation control unit 150 of the TV set 10 determines the reduction amount and the reduction time of the luminance, and transmits the light modulation signal containing such information to the reproduction apparatus 30, different arrangements may be made. For example, the TV set 10 may transmit the light modulation signal containing information that the image signal output unit 111 is outputting a 3D image, and information on the crosstalk amount, genre, and scene change, to the reproduction apparatus 30. Then the light modulation unit 320 of the reproduction apparatus 30 may determine the reduction amount and the reduction time of the luminance on the basis of such information contained in the light modulation signal received, for controlling the luminance of the light emitting unit 310.

Although the foregoing embodiment refers to the case where the light modulation control unit 150 of the TV set 10 controls the luminance of the light emitting unit 310 of the reproduction apparatus 30, different arrangements may be made. For example, the light modulation control unit 150 may control the luminance of the light emitting unit 130 of the TV set 10, or the luminance of the light emitting unit 210 of the 3D image viewing glasses 20.

Alternatively, the light modulation control unit 240 of the 3D image viewing glasses 20 may control the luminance of the light emitting unit 210 of the 3D image viewing glasses 20, or the luminance of the light emitting unit 310 of the reproduction apparatus 30. In this case, the light modulation control unit 240 may detect whether the synchronization signal reception unit 230 is receiving a synchronization signal from the TV set 10, to thereby decide whether the image signal output unit 111 is outputting a 3D image. Other types of operation have already been described above, and hence the description will not be repeated.

According to the foregoing embodiment, the stereoscopic vision is obtained by alternately outputting a right eye image and a left eye image having a parallax therebetween frame by frame, and opening and closing the shutters of the 3D image viewing glasses 20 to thereby allow the viewer to view the right eye image only with the right eye and the left eye image only with the left eye, however different methods may be adopted.

For example, the present invention is also applicable to an image signal processing apparatus that employs a lenticular lens to provide a stereoscopic vision. In this case, the image signal processing apparatus may recognize the position of the viewer from an image taken by the camera, to thereby turn on an alarm lamp, an example of the light emitting unit, in the case where the viewer is at such a position where the 3D image cannot be seen (position where the displayed image cannot be recognized as a 3D image), and turn off (reduce the luminance of) the alarm lamp in the case where the viewer is at such a position where the 3D image can be seen (position where the displayed image can be recognized as a 3D image). In the case of utilizing glasses to obtain the stereoscopic vision, polarized lenses may be employed instead of the shutter, to provide different images to the left and right eyes.

### Additional Embodiments

Although the present invention has been described with reference to the foregoing embodiment, naturally the present invention is not limited to the embodiment. The following examples are also within the scope of the present invention.

The units referred to above are actually a computer system including a microprocessor, a ROM, a RAM, a hard disk unit, a display unit, a keyboard, a mouse, and so forth. The RAM and the hard disk unit store therein a computer program. By operation of the microprocessor according to the computer program, the units perform the respective functions. The computer program is composed of a plurality of combinations of command codes each giving an instruction to the computer for executing a predetermined function.

A part or whole of the constituents of the foregoing units may be contained in a single system large-scale integration (LSI). The system LSI is an ultra-multifunction LSI containing a plurality of constituents integrated on a single chip, which can be specifically exemplified by a computer system including a microprocessor, a ROM, a RAM, and so on. The RAM stores therein a computer program. By operation of the microprocessor according to the computer program, the system LSI performs the functions.

A part or whole of the constituents of the foregoing units may be contained in an IC card or a single module that can be removably attached to the constituents. The IC card or the module is a computer system including a microprocessor, a ROM, a RAM, and so forth. The IC card or the module may include the ultra-multifunction LSI. By operation of the microprocessor according to the computer program, the IC card or the module performs the functions. The IC card or the module may be tamper-resistant.

The present invention may be realized in a form of the methods stated in the foregoing descriptions. Alternatively, the present invention may be realized as a computer program that causes a computer to perform those methods, or as a digital signal composed of the computer program.

Also, the present invention may be realized as a computer-readable recording medium such as a flexible disk, a hard disk, a CD-ROM, a MO, a DVD, a DVD-ROM, a DVD-RAM, a BD, or a semiconductor memory, containing a computer program or a digital signal. Alternatively, the present invention may be realized in a form of the digital signal recorded in the foregoing recording media.

Further, the present invention may include transmitting the computer program or the digital signal through an electrical communication line, a wireless or wired communication line, a network typically exemplified by the Internet, a data broadcast, and so forth.

Further, the present invention may be realized as a computer system including a microprocessor and a memory, and the memory may store therein the computer program, and the microprocessor may be configured to operate in accordance with the computer program.

Still further, the present invention may be realized by means of another independent computer system, by transferring the program or the digital signal recorded in a recording medium, or transmitting the program or the digital signal through a network.

The foregoing embodiment and one or more of the variations may be combined.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention enables a user to enjoy 3D image viewing in an optimum viewing circumstance, not only at home but also outdoors, for example in musical concerts or other events. Also, the present invention is applicable not only to a TV set but also to all kinds of displayers including a screen, capable of displaying a 3D image.

What is claimed is:

1. An image signal processing apparatus that operates in association with a light emitting apparatus including a light emitting unit, said image signal processing apparatus comprising:
an output unit configured to output an image;
a detection unit configured to detect an output of a three-dimensional (3D) image from said output unit; and
a light modulation control unit configured to cause the light emitting apparatus to reduce a luminance of the light emitting unit, when said detection unit detects an output of the 3D image from said output unit.

2. The image signal processing apparatus according to claim 1,
wherein said light modulation control unit is configured to gradually reduce the luminance of the light emitting unit over a predetermined period of time.

3. The image signal processing apparatus according to claim 1,
wherein said detection unit is further configured to detect a feature of the 3D image outputted from said output unit; and
said light modulation control unit is configured to change an amount of reduction in luminance of the light emitting unit, in accordance with the feature of the 3D image detected by said detection unit.

4. The image signal processing apparatus according to claim 3,
wherein said detection unit is configured to detect an amount of crosstalk of the 3D image outputted from said output unit; and
said light modulation control unit is configured to reduce the luminance of the light emitting unit by the larger amount, the larger the crosstalk amount detected by said detection unit is.

5. The image signal processing apparatus according to claim 3,
wherein said output unit includes:
an image signal output unit configured to alternately output a right eye image and a left eye image having a parallax between each other; and
a synchronization signal output unit configured to output a synchronization signal that opens a lens of 3D image viewing glasses worn by a viewer corresponding to an image outputted by said image signal output unit and closes the other lens of the 3D image viewing glasses;
said detection unit is configured to detect a time during which the lens of the 3D image viewing glasses is open; and
said light modulation control unit is configured to reduce the luminance of the light emitting unit by the larger amount, the shorter the time detected by said detection unit during which the lens of the 3D image viewing glasses is open is.

6. The image signal processing apparatus according to claim 3,
wherein said output unit is configured to output the 3D image in one of a plurality of output modes for each of which a different peak luminance is specified;
said detection unit is configured to detect the output mode of the 3D image outputted from said output unit; and
said light modulation control unit is configured to reduce the luminance of the light emitting unit by the larger amount, the lower the peak luminance identified from the output mode detected by said detection unit is.

7. The image signal processing apparatus according to claim 3,
wherein said detection unit is configured to detect a scene change of the 3D image outputted from said output unit; and
said light modulation control unit is configured to reduce the luminance of the light emitting unit in the case where a luminance of an image following the scene change detected by said detection unit is lower than a luminance of an image preceding the scene change, and to reduce the luminance of the light emitting unit by the larger amount, the lower the luminance of the image following the scene change detected by said detection unit is.

8. The image signal processing apparatus according to claim 7,
wherein said light modulation control unit is further configured to increase the luminance of the light emitting unit in the case where luminance of an image following the scene change detected by said detection unit is higher than luminance of an image preceding the scene change, and to increase the luminance of the light emitting unit by the larger amount, the higher the luminance of the image following the scene change detected by said detection unit is.

9. The image signal processing apparatus according to claim 1,
wherein said detection unit is further configured to detect that said output unit has stopped outputting the 3D image; and
said light modulation control unit is further configured to increase the luminance of the light emitting unit, when said detection unit detects that the 3D image has stopped being outputted.

10. The image signal processing apparatus according to claim 1, wherein the light emitting apparatus is incorporated.

11. A light emitting apparatus that operates in association with an image signal processing apparatus, said light emitting apparatus comprising:
a light emitting unit configured to change luminance; and
a light modulation unit configured to reduce the luminance of the light emitting unit when the image signal processing apparatus outputs a 3D image.

12. 3D image viewing glasses that operate in association with an image signal processing apparatus and a light emitting apparatus including a light emitting unit, said 3D image viewing glasses comprising:
a synchronization signal reception unit configured to receive a synchronization signal indicating a timing for a change in transmittance of left and right lenses from the image signal processing apparatus;
a left and right pair of lenses configured to change transmittance in accordance with the synchronization signal received by said synchronization signal reception unit; and
a light modulation control unit configured to cause the light emitting apparatus to reduce luminance of the light emitting unit, when said synchronization signal reception unit receives the synchronization signal.

13. An image signal processing system, comprising:
an image signal processing apparatus; and
a light emitting apparatus,
wherein said image signal processing apparatus includes:
an output unit configured to output an image;
a detection unit configured to detect an output of a 3D image from said output unit; and
a light modulation control unit configured to cause said light emitting apparatus to reduce luminance of a light emitting unit thereof, when said detection unit detects an output of the 3D image from said output unit, and
said light emitting apparatus includes:
said light emitting unit configured to change luminance; and
a light modulation unit configured to reduce the luminance of said light emitting unit under control by said light modulation control unit.

14. A method of processing an image signal to be performed utilizing an image signal processing apparatus and a light emitting apparatus in association therebetween, said method comprising:
causing the image signal processing apparatus to output an image;
detecting an output of a 3D image from the image signal processing apparatus; and
controlling modulation of light, including causing the light emitting apparatus to reduce luminance of a light emitting unit thereof in response to said detecting an output of a 3D image from the image signal processing apparatus.
